(19) United States
(12) Patent Application Publication
(10) Pub. No.: US 2020/0301015 A1
(43) Pub. Date: Sep. 24, 2020

(54) SYSTEMS AND METHODS FOR LOCALIZATION

(71) Applicant: Foresight AI Inc., Los Gatos, CA (US)

(72) Inventors: Matheen Siddiqui, Long Beach, CA (US); Yuping Lin, San Jose, CA (US); Cheng-Yi Lin, Santa Clara, CA (US); Chang Yuan, Los Gatos, CA (US)

(21) Appl. No.: 16/567,098

(22) Filed: Sep. 11, 2019

Related U.S. Application Data
(60) Provisional application No. 62/821,905, filed on Mar. 21, 2019.

(51) Int. Cl. G01S 17/89; G06K 9/00; G06K 9/62; G06N 3/08; B64C 39/02

(52) U.S. Cl. CPC G01S 17/89; G06K 9/0063; B64C 2201/127; G06N 3/08; B64C 39/024; G06K 9/6259

(57) ABSTRACT

Systems and methods for localization are provided. In one aspect, a LIDAR scan is captured from above to generate a point cloud. One or more locations may be sampled in the point cloud and LIDAR scans may be simulated at each location. The sampled locations and associated simulated LIDAR scans may be used to train a regressor to localize vehicles in the environment that are at poses different from the pose from which the LIDAR point cloud was captured. In one aspect, a mapping UAV systematically scans an environment with a camera to generate a plurality of map images. The map images are stitched together into an orthographic image. A runtime UAV captures one or more runtime images of the environment with a camera. Feature matching is performed between the runtime images and the orthographic image for localization. In one aspect, a first machine learning model is trained to transform a camera image into a LIDAR image and a second machine learning model is trained to estimate a pose based on a LIDAR image. A runtime image may be input to the first machine learning model to generate a simulated LIDAR scan. The simulated LIDAR scan may be input to the second machine learning model to estimate a pose, which localizes the vehicle.

### CROSS-REFERENCE TO RELATED APPLICATION

This application claims the benefit of U.S. Provisional Application No. 62/821,905, filed on Mar. 21, 2019, which is hereby incorporated by reference in its entirety.

### BACKGROUND

Unmanned aerial vehicles (UAVs) are capable of traveling through the air without a physically-present human operator. UAVs may operate in an autonomous mode, remote-control mode, or partially autonomous mode

In a fully autonomous mode, the UAV may automatically determine its own path and operate one or more propulsion components and control components to navigate along the path.

In a remote-control mode, a human operator that is remote from the UAV controls the UAV to travel along a flight path. The flight may be developed by a human or by a computer. In a partially autonomous mode, some aspects of the UAVs flight may be performed autonomously by the UAV and other aspects of the flight may be performed under remote control.

Localization is the process of determining the location of an entity or object. Localizing a UAV may be desirable for path planning, obstacle avoidance, guidance toward completion of the UAV's task, and other reasons. Current methods of localization have numerous drawbacks.

Global Positioning System (GPS) may be used for localization, however most GPS systems only achieve of an accuracy of plus or minus several meters, which is insufficient for many applications. Moreover, a high-quality GPS system with higher accuracy is often expensive and therefore prohibitive for many applications.

Light Detection and Ranging (LIDAR) navigation has been performed where an environment is scanned using a LIDAR scanner to generate a 3D point cloud that serves as a map of the environment. During usage, inference may be performed on a new LIDAR point cloud to identify a vehicle location. A vehicle may scan the environment to generate a LIDAR point cloud and the inference-time LIDAR point cloud may be compared against the 3D point cloud of the environment to identify a vehicle location. However, LIDAR localization includes a number of disadvantages including the high cost and bulkiness of the LIDAR equipment.

Image-based localization may be performed in which images of an environment are captured during a mapping process. During usage, inference may be performed on new images that are captured from a vehicle. The inference-time images may be compared against the images of the environment to identify the vehicle location. However, image-based localization can be significantly affected by illumination. A vehicle that is performing localization at a different time of day than the environmental images were taken may not be able to localize well with an image-based approach. Moreover, storing the environmental images needed for image-based localization may require a large amount of memory.

Improved localization systems and methods are needed to address the aforementioned disadvantages.

### BRIEF DESCRIPTION OF THE DRAWINGS

The present disclosure will become better understood from the detailed description and the drawings, a brief summary of which is provided below.

FIG. 1 illustrates an exemplary environment in which systems herein may operate.

FIG. 2 illustrates an exemplary embodiment of a UAV.

FIG. 3 illustrates an exemplary embodiment of a computer system that may be used in some embodiments.

FIG. 4A illustrates an exemplary method for training a regressor to generate a pose from LIDAR scans.

FIG. 4B illustrates an exemplary method for localizing a vehicle using a regressor.

FIG. 5 illustrates one exemplary embodiment of a system and method for performing ground-level localization using aerially generated data.

FIG. 6 illustrates an exemplary environment in which some embodiments may operate.

FIG. 7 illustrates an exemplary embodiment of a computer system that may be used in some embodiments.

FIG. 8A illustrates an exemplary method for generating orthographic image.

FIG. 8B illustrates an exemplary method for generating and storing feature descriptors from an orthographic image.

FIG. 8C illustrates an exemplary method for localizing a runtime UAV.

FIG. 8D illustrates an exemplary method that may optionally be performed in some embodiments to further refine the localization of a runtime UAV.

FIG. 9 illustrates an exemplary flow chart of a localization process for a runtime UAV.

FIG. 10A illustrates exemplary map images and runtime image.

FIG. 10B illustrates an exemplary orthographic image.

FIG. 11 illustrates an exemplary environment in which some embodiments may operate.

FIG. 12 illustrates an exemplary embodiment of a computer system that may be used in some embodiments.

FIG. 13 illustrates an exemplary flow chart of a localization process for a runtime UAV.

FIG. 14A illustrates an exemplary method for localizing a runtime UAV.

FIG. 14B illustrates an exemplary method for training a camera to LIDAR model.

FIG. 14C illustrates an exemplary method for training a LIDAR to pose model.

FIG. 15 illustrates exemplary camera images and corresponding simulated LIDAR point clouds generated by a camera to LIDAR model.

### DETAILED DESCRIPTION

For simplicity and illustrative purposes, the principles of the present teachings are described by referring mainly to examples of various implementations thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific examples of various implementations. Logical and structural changes can be made to the examples of the various implementations without departing from the spirit and scope of the present teachings. The following detailed description is, therefore, not to be taken in a limiting sense and the scope of the present teachings is defined by the appended claims and their equivalents.

In addition, it should be understood that steps of the examples of the methods set forth in the present disclosure can be performed in different orders than the order presented in the present disclosure. Furthermore, some steps of the examples of the methods can be performed in parallel rather than being performed sequentially. Also, the steps of the examples of the methods can be performed in a network environment in which some steps are performed by different computers in the networked environment.

Some implementations are implemented by a computer system. A computer system can include a processor, a memory, and a non-transitory computer-readable medium. The memory and non-transitory medium can store instructions for performing methods and steps described herein.

Embodiments herein relate to the use of UAVs. The terms “unmanned aerial vehicle” and “UAV” may refer to an aerial vehicle without a physically-present human operator. The terms “drone,” “unmanned aerial vehicle system” (UAVS), or “unmanned aerial system” (UAS) may also be used to refer to a UAV.

UAVs may operate autonomously, partially autonomously, or by remote control of a human operator. An autonomous UAV may automatically develop a flight path and navigate along the flight path through a computer processor that operates one or more propulsion components and control components. In some embodiments, the autonomous UAV may require a manually developed flight path but may navigate automatically along the flight path without human control or intervention. In some embodiments, an autonomous UAV is supervised by a human operator, who can take over control if necessary, even though control is by default performed by a computer processor. A remote-control UAV may be under the control of a human operator who is remote from the UAV. The human operator may control the UAV through a control interface. Control commands may be received from the human operator at the control interface and transmitted, through wireless or wired communication, to the UAV. One or more propulsion components and control components may be controlled through operation of the human-operated control interface. Moreover, the UAV may record video, photo, and sensor data to transmit back to the human operator to allow the human operator to perceive the vicinity of the UAV. A partially autonomous UAV may include both autonomous and remote-control aspects. In one embodiment, the autonomous and remote-control commands may occur at different levels of abstraction. For example, a human operator may input commands for the UAV to travel from a start location to an end location, and an autonomous piloting system may automatically perform the low-level navigation tasks for controlling the propulsion and control systems of the UAV to fly the UAV from the start location to the end location. In such an embodiment, the human may provide high-level control and the UAV may autonomously perform low-level control. Vice versa, an autonomous UAV may perform high-level control in the form of autonomously developing a flight path and handing off the low-level control to the human-operator to perform the individual real-time control necessary to guide the UAV along the flight path. In other embodiments of a partially autonomous UAV, the split of control between the autonomous and remote-control aspect may be at the same level of abstraction. For example, the UAV may be flown in an autonomous mode until an obstacle or other difficult to navigate situation is encountered, when control is switched to remote-control by a human operator.

A UAV may be of various forms. For example, a UAV may be a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, an ornithopter, and so on.

In one embodiment, a UAV is a rotorcraft. A rotorcraft includes helicopters, which typically include two rotors, and multicopters, which have more than two rotors. In a rotorcraft, the rotors provide propulsion and control for the vehicle. Each rotor includes blades attached to a motor, and the rotors may allow the rotorcraft to take off and land vertically, to maneuver in any direction, and to hover. The pitch of the blades may be adjusted as a group or differentially to allow the rotorcraft to perform aerial maneuvers. Additionally, the rotorcraft may propel and maneuver itself by adjusting the rotation rate of the motors, collectively or differentially.

In one embodiment, a UAV is a tail-sitter UAV. A tail-sitter UAV may comprise fixed wings for providing lift and allowing the UAV to glide horizontally. However, during launch the tail-sitter UAV may be positioned vertically with fins and wings resting on the ground and stabilizing the UAV in a vertical position. The tail-sitter UAV may take off by operating propellers to generate upward thrust. In the air, the tail-sitter UAV may use one or more flaps to turn itself into a horizontal position. The propellers may provide forward thrust so that the tail-sitter UAV may fly in a similar manner as a typical airplane.

In one embodiment, the UAV is a fixed-wing aircraft, which may also be referred to as an airplane, aeroplane, or a plane. A fixed-wing aircraft may comprise a fuselage and stationary wings that generate lift based on the wing shape and the vehicle's forward airspeed. In a common configuration, a fixed-wing UAV includes two horizontal wings, a vertical stabilizer (also referred to as a fin) to stabilize the plane's yaw, a horizontal stabilizer (also referred to as an elevator or tailplane) to stabilize pitch (tilt up or down), and a propulsion unit. The propulsion unit may include, for example, a motor, shaft, and propeller, or a jet engine.

The aforementioned embodiments are exemplary only and the UAV may take any number of other forms.

Some embodiments also relate to ground vehicles. Ground vehicles may also be autonomous, partially autonomous, or manually driven. Autonomous ground vehicles are driven by a computer system and include, for example, self-driving cars and self-driving vehicles. Partially autonomous ground vehicles may operate under partial autonomous and partial manual control. Manually driven ground vehicles may be operated by a driver located in the vehicle or a remotely located operator who is located outside of the vehicle. Ground vehicles herein may be manned or unmanned. Ground vehicles include, for example, cars, trucks, motorcycles, tractors, delivery robots, scooters, and so on.

Localization Based on Vehicle LIDAR Using Aerially Generated Map

One embodiment relates to more efficient methods for generating LIDAR maps for ground vehicles. Many self-driving ground vehicles rely on the use of LIDAR for precise localization. However, current processes for generating LIDAR maps for ground vehicles are time consuming because ground vehicles carrying LIDAR sensors must travel to each location that is desired to be mapped and scan them. It is advantageous to not have to use ground-based LIDAR scans to build a LIDAR map. Systems and methods herein allow for aerial mapping of environments with LIDAR and using the resulting point clouds for localization of ground vehicles. Aerial mapping UAVs may map locations more quickly than ground-based vehicles and may access areas that ground-based vehicles cannot. Efficiencies are gained because aerial collection of LIDAR data is faster and more efficient than creation of the LIDAR maps from the ground.

In an embodiment, a UAV scans an environment using a LIDAR to generate a LIDAR point cloud. A plurality of sampled locations are selected in the LIDAR point cloud and, at each sampled location, a simulated LIDAR scan is generated that simulates the LIDAR returns from a virtual LIDAR located at that location. In one embodiment, the sampled locations are at or near ground level. In other embodiments, the sampled locations may be at locations other than ground level. A training set is generated from the sampled locations and simulated LIDAR scans, where the sampled location is the training label and the simulated LIDAR scan is the training input. A regressor is trained on the training set to predict a pose from a LIDAR scan.

In an embodiment, the regressor may be used to localize a ground vehicle. A ground vehicle may generate a LIDAR scan, which may comprise a 3D point cloud, and input the LIDAR scan into the regressor to obtain a predicted pose of the ground vehicle.

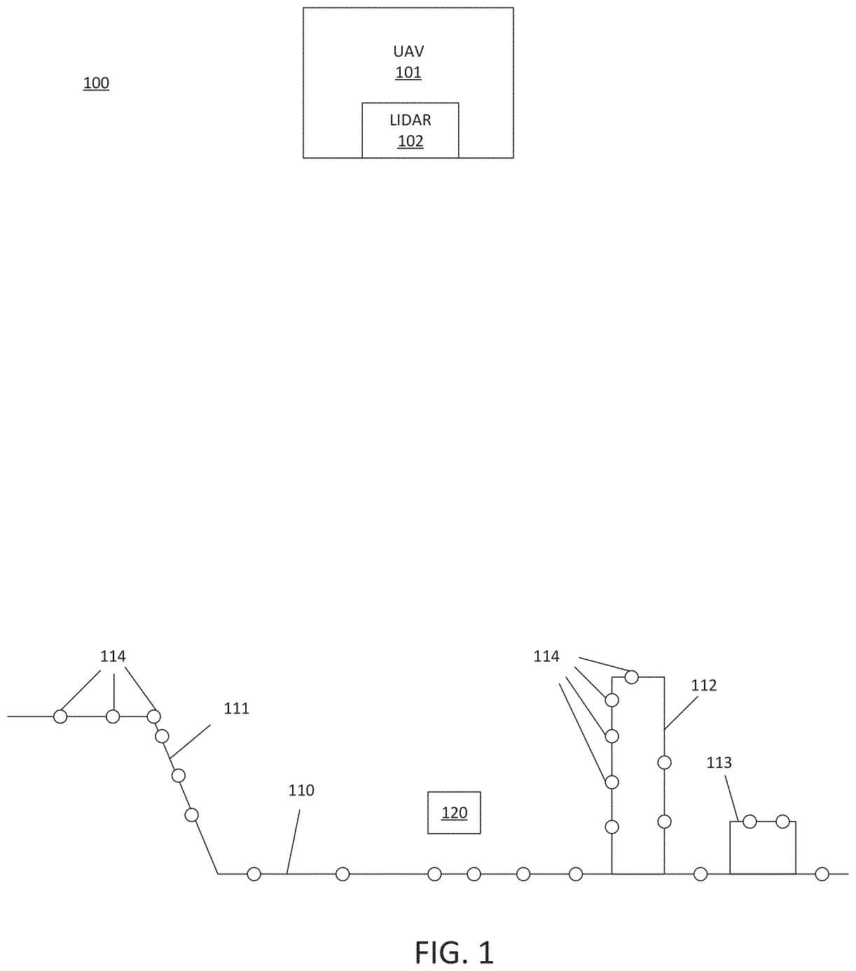

FIG. 1 illustrates an exemplary environment 100 in which systems herein may operate. A UAV 101 may fly in the air above the ground 110. The UAV may include a LIDAR 102 directed at the ground to scan the ground to collect point data 114. The LIDAR may scan the environment 100 and generate a 3D point cloud 331 that represents the environment. Each point 114 in the point cloud 331 may comprise (X, Y, Z) coordinates and an intensity value that measures the light response. In this embodiment, the 3D point cloud 331 of LIDAR data is generated from the aerial viewpoint of the UAV.

The point cloud may be indicative of objects in the environment due to the point data corresponding to points of light reflectance off of environmental objects. The environment may include changes in elevation 111 and objects 113, 114 that reflect light. These environmental objects may be represented by a plurality of points representing the surfaces of the objects in the point cloud 331. Environmental objects may include, for example, trees, foliage, shrubbery, vehicles, signs, buildings, structures, geographic features, hills, mountains, and so on.

Based on the 3D point cloud 331 an environmental map 332 may be built, where the environmental map 332 comprises the environment in which the 3D point cloud 331 is situated. In an embodiment, the environmental map 332 comprises a 3-dimensional space in which the 3D point cloud 331 is situated.

One or more sample locations 120 may be generated in the environmental map 332 and, specifically, inside the 3D point cloud 331. A LIDAR scan simulator 322 may be used to simulate the results of a LIDAR scan taken from each sample location 120 within the 3D point cloud 331. LIDAR scan simulator 322 may comprise a software program. The simulated LIDAR scan comprises the predicted LIDAR returns from a LIDAR scan located in the environment 100 represented by the 3D point cloud 331. The LIDAR scan simulator 322 may generate the simulated LIDAR scan by situating a virtual LIDAR scanner at the sample location 120 and simulating the LIDAR returns that would be obtained by the virtual LIDAR scanner. The simulated LIDAR returns may be determined by collecting the point data of the 3D point cloud 331 that is visible from sample location 120, which is a different perspective of the 3D point cloud 331 than the aerial view from which the 3D point cloud 331 was generated from data collected from the UAV 101. Point data that exists in the 3D point cloud 331 but is obstructed by other objects or points in the 3D point cloud 331 may be excluded from the simulated LIDAR scan.

The one or more sample locations 120 and their corresponding simulated LIDAR scans may be stored as training examples, where the sample location 120 comprises the training label and the simulated LIDAR scan comprises the training input. A regressor 321 may be trained using the training examples to be able to generate a pose, comprising an (X, Y, Z) location and orientation, based on a LIDAR scan. The regressor 321 may comprise internal parameters that are adjusted through the training process on the training examples and build an internal representation of a function for mapping from a LIDAR scan to a pose. Thus, the regressor is trained on simulated LIDAR scans from a ground-level view in a 3D point cloud that was generated from an aerial LIDAR scan.

At a later time, the regressor 321 is used to localize ground vehicles traveling in environment 100. A ground vehicle may include a LIDAR scanner and may generate a 3D point cloud from its environment. The 3D point cloud may be input to the regressor to generate a location and orientation of the ground vehicle. In some embodiments, the ground vehicle comprises a software system that includes a stored version of the regressor 321. In other embodiments, the ground vehicle may transmit the 3D point cloud to an external server that performs regression by the regressor 321 and transmits the resulting pose information back to the ground vehicle.

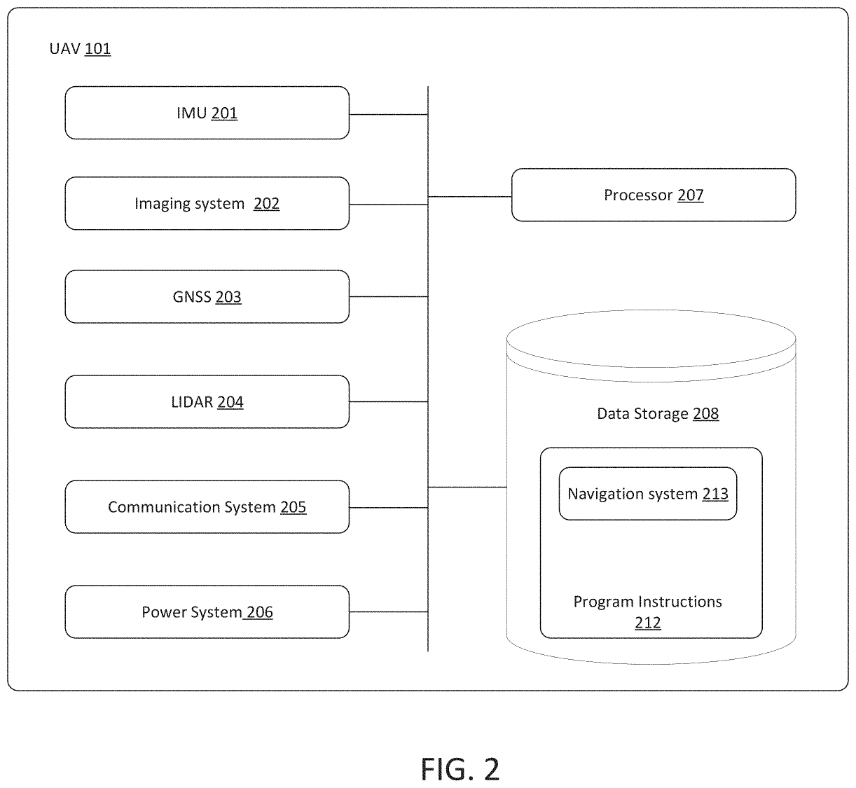

FIG. 2 illustrates an exemplary embodiment of a UAV 101. UAV 101 may comprise a processor 207 and data storage 208, including one or more program instructions 212, in addition to sensor systems, a communication system 205, and power system 206.

IMU 201 comprise components for determining the orientation, position, and movement of the UAV. The IMU 201 may comprise an accelerometer and gyroscope, where the accelerometer may measure the orientation of the vehicle with respect to the earth and the gyroscope measures the rate of rotation around an axis. The IMU 201 may optionally include other sensors such as magnetometers and pressure sensors. A magnetometer may measure direction by using an electronic compass to determine heading information. A pressure sensor may be used to determine the altitude of the UAV.

Imaging system 202 may comprise components for imaging the environment in the vicinity of the UAV. In an embodiment, the imaging system 202 comprises a red, green, and blue (RGB) camera. An RGB camera may capture photographic and video imagery in the visible spectrum of RGB light. Imaging system 202 may optionally include other imaging components such as an infra-red camera for capturing light in the infra-red spectrum or a depth sensor for capturing depth information in an image. The imaging system 202 may comprise a still camera, a video camera, or both. The imaging system 202 may be used for object detection, localization, mapping, and other applications.

GNSS receiver 203 may communicate with satellites to provide coordinates of the UAV. In one example, the GNSS receiver 203 is a GPS receiver where GPS is one example of a GNSS system. A GPS receiver may provide GPS coordinates of the UAV. GPS coordinates may have a relatively high margin of error and so additional sensor systems may be used in conjunction with GPS to increase the accuracy of localization of the UAV.

LIDAR 204 may comprise an emitter that generates pulsed laser light and a detector for receiving the reflected pulses. Differences in laser return times and wave lengths may be used to generate a 3D point cloud comprising location information in 3D space and laser reflection intensities. The 3D point cloud may be processed to build a map of the 3D environment, including both topography and objects.

Communication system 205 may comprise one or more wireless interfaces or wireline interfaces to enable the UAV to communicate via one or more networks. Wireless interfaces may enable communication over one or more wireless communication protocols, such as Bluetooth, Wi-Fi, Long-Term Evolution (LTE), WiMAX, radio-frequency ID (RFID), near-field communication (NFC), and other wireless communication protocols. Wireline interfaces may include interfaces to wired networks such as Ethernet, universal serial bus (USB), or other wired networks such as coaxial cable, optical link, fiber-optic link, and so on. Communication system 205 may enable the receiving of remote-control commands from a human operator. Communication system 205 may also enable the sending of sensor data from the UAV to remotely located computer systems for processing, storage, or display.

Power system 206 may comprise components for providing power to the UAV. In an embodiment, the power system 206 may comprise one or more batteries. In other embodiments, the power system 206 may comprise solid or liquid fuel.

Processor 207 may comprise a computer processor for executing one or more program instructions 212 on the data storage 208. The processor may be a general-purpose processor or a special purpose processor (e.g., digital signal processors, application specific integrated circuits, and so on). The processor may be configured to execute program constructions to provide the functionality of a UAV described herein.

Data storage 208 may comprise any form of computer-readable storage that can be read or accessed by processor 207. The data storage may be integrated with or separate from the processor 207. Data storage may be temporary, permanent, or semi-permanent and may comprise, for example, RAM, ROM, optical media, flash memory, hard disk, solid state drives (SSD), mechanical hard drives, or other storage. While illustrated as a single data storage 208, it should be understood that data storage 208 may comprise any number of separate or integrated data storages.

The data storage 208 may store one or more program instructions 212 for implementing the functionality described herein. Navigation system 213 may be stored as program instructions stored in the data storage 208. The navigation system 213 may comprise instructions for moving and maneuvering the UAV by issuing instructions to the propulsion components and control components of the UAV.

UAV 101 may include additional components not illustrated in FIG. 2. For example, UAV 101 may include a plurality of additional sensors such as radar, ultra-sonic sensors, proximity sensors, temperature sensors, light sensors, microphones, and so on. UAV 101 may also include output systems such as speakers, lights, display screens, and so on.

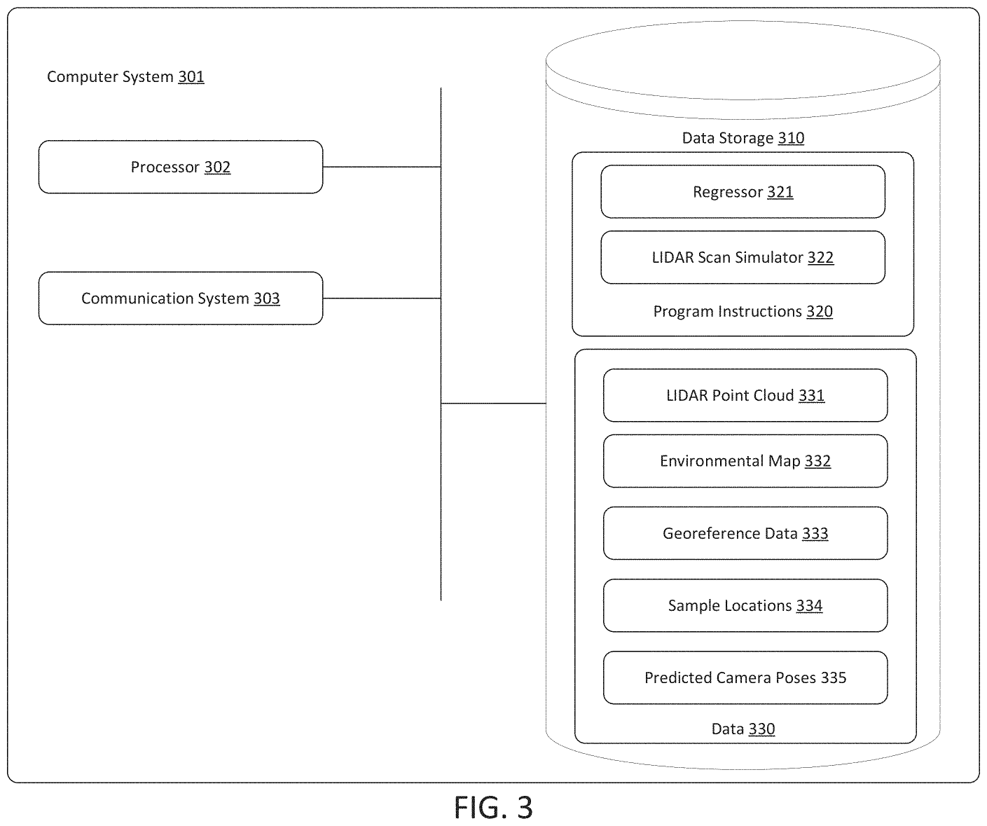

FIG. 3 illustrates an exemplary embodiment of a computer system 301 that may be used in some embodiments to perform functionality described herein. The computer system 301 may implement functionality to store the LIDAR point cloud 331 generated by UAV 101, generate sample locations 334 in the point cloud 331, and train regressor 321 to perform localization.

In some embodiments, the computer system 301 is onboard the UAV 101. For example, in one embodiment, the processor 302 is the processor 207, the communication system 303 is the communication system 205, and the data storage 310 is the data storage 208.

In other embodiments, the computer system 301 may be offboard the UAV 101 and may receive the LIDAR data collected by LIDAR 204 through receipt by communication system 303.

The processor 302 may comprise a computer processor for executing one or more program instructions 320 on the data storage 310. The processor may be a general-purpose processor or a special purpose processor (e.g., digital signal processors, application specific integrated circuits, and so on). The processor may be configured to execute program constructions to provide the functionality of ground-aware flight planning as described herein.

Communication system 303 may comprise one or more wireless interfaces or wirelines interfaces to enable the computer system 301 to communicate via one or more networks. Wireless interfaces may enable communication over one or more wireless communication protocols, such as Bluetooth, Wi-Fi, Long-Term Evolution (LTE), WiMAX, radio-frequency ID (RFID), near-field communication (NFC), and other wireless communication protocols. Wireline interfaces may include interfaces to wired networks such as Ethernet, universal serial bus (USB), or other wired networks such as coaxial cable, optical link, fiber-optic link, and so on. When the computer system 301 is offboard of the UAV 101, the communication system 303 may enable the receiving of sensor data from the UAV 101. Moreover, communication system 303 may also enable the sending of remote control instructions, or an entire or partial flight path, to the UAV 101.

The data storage 310 may store one or more program instructions 320 and data 330 for implementing the functionality described herein.

LIDAR point cloud 331 may comprise a collection of 3D point data collected from a LIDAR system. Environmental map 332 may comprise a 3D dimensional environment in which the LIDAR point cloud 331 is situated.

Georeference data 333 may comprise geographic data relating the environmental map 332 and LIDAR point cloud 331 to geographic coordinates. The georeferenced data 333 may provide a correspondence between coordinates in the environmental map 332 to geographic coordinates in the world.

Sample locations 334 comprise one or more locations in the environmental map 332 and point cloud 331 that have been sampled to use as training data for regressor 321. The sample locations 334 may be selected using random, pseudo-random, arbitrary, or systematic methods of selection.

Predicted camera poses 335 are predicted camera poses that may be generated through operation of the regressor on LIDAR scan data, whether from real or simulated LIDAR scans.

Regressor 321 may comprise a machine learning model for performing regression. Regressor may accept as input one or more input values and output a real-valued value, such as a floating point or double-precision value. Regressor may comprise a neural network, deep neural network, random forest, linear regressor, non-linear regressor, or other regression models.

LIDAR scan simulator 322 may comprise program instructions for generating a simulated LIDAR scan from 3D point cloud 331. The simulated LIDAR scan may comprise a new 3D point cloud generated from 3D point cloud 331 from the perspective of a virtual LIDAR scanner. Simulated LIDAR scans may be referred to as synthetic LIDAR scans or artificially generated LIDAR scans.

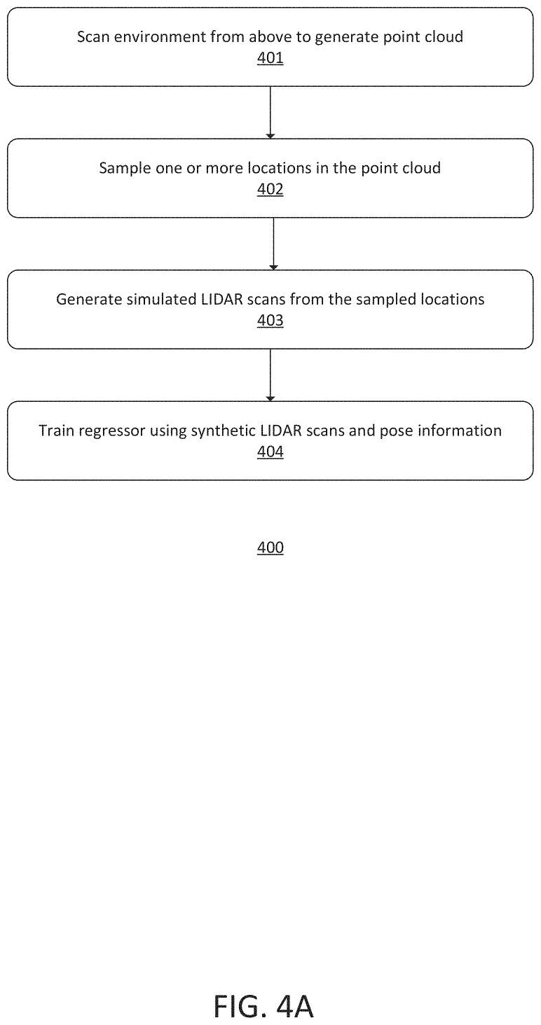

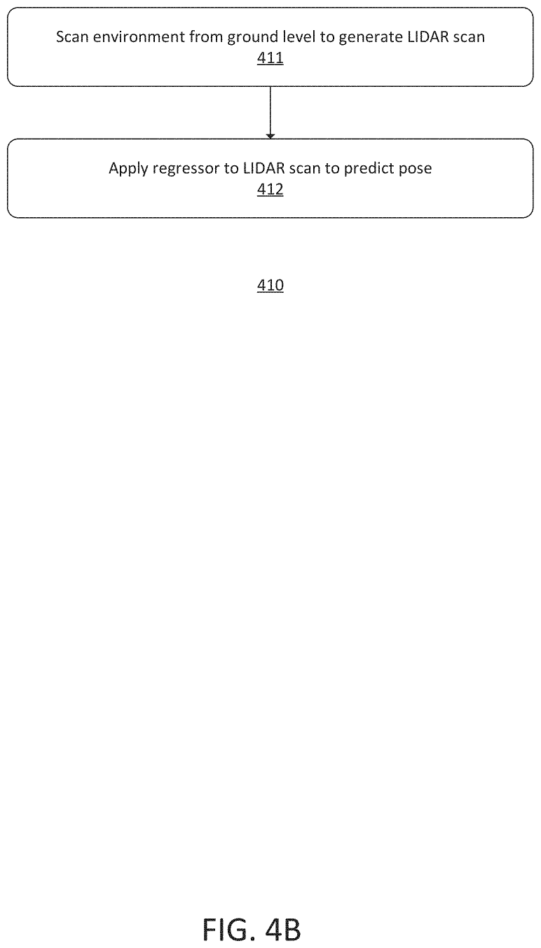

FIG. 4A illustrates an exemplary method 400 for training regressor 321 to generate a pose from LIDAR scans. In step 401, environment 100 is scanned from above by a LIDAR 102 mounted on UAV 101 to generate point cloud 331. The point cloud 331 is generated from the aerial perspective of the UAV 101.

In step 402, one or more locations 334 are sampled in the point cloud. In an embodiment, the sampled locations 334 are at or near ground level to simulate locations that a ground vehicle may occupy. This enables the regressor 321 to be trained to localize ground vehicles. In other embodiments, sampled locations 334 may also be taken at locations that are not ground level, such as aerial locations.

In step 403, simulated LIDAR scans are generated from the sampled locations 403 using LIDAR scan simulator 322. The simulated LIDAR scans are generated by placing a virtual LIDAR scanner at the sampled locations 403 and simulating the returns that the virtual LIDAR scanner would collect from the environment, based on the point cloud 331. The LIDAR scan simulator 322 may generate the simulated LIDAR scan by sampling from the points in the point cloud that are visible from the sampled location and not sampling from points that are obstructed by other objects. The existence and location of obstructing objects may be determined based on the distribution of points in the point cloud 331.

In step 404, regressor 321 may be trained using the simulated LIDAR scans and sampled locations 403. The sampled locations 403 may include both (X, Y, Z) coordinates and orientation, which together comprise a pose. The pose and simulated LIDAR scans may be input to the regressor 321 as training examples to train the regressor 321 to develop internal parameters representing a function mapping from LIDAR scans to a pose. As a result, trained regressor 321 may be used to map from a LIDAR scan to a pose.

FIG. 4B illustrates an exemplary method 401 for localizing a vehicle using the regressor 321. In step 411, the environment is scanned using LIDAR from ground level to generate a LIDAR scan comprising a point cloud. In step 412, the regressor 321 is applied to the LIDAR scan, and the regressor 321 outputs a predicted pose of the vehicle. The predicted pose of the vehicle comprises the localization of the vehicle.

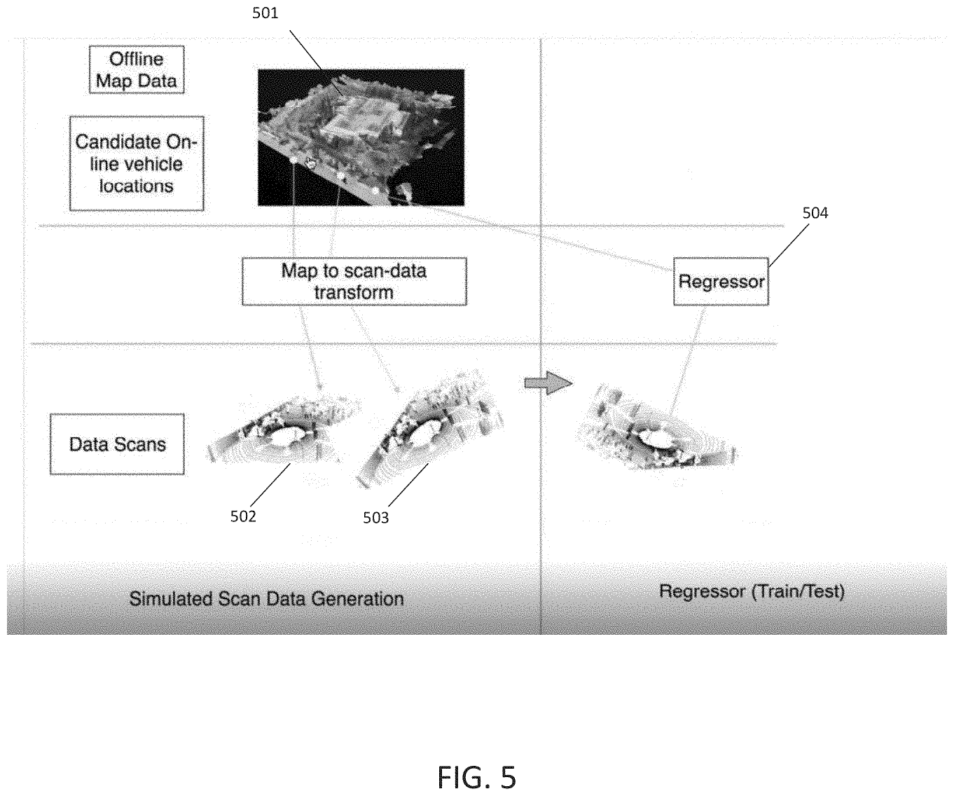

FIG. 5 illustrates one exemplary embodiment of a system and method for performing ground-level localization using aerially generated data. Map data 501 corresponds to a point cloud of points generated across multiple LIDAR scans from UAVs. Candidate on-line vehicle locations are generated, which are used as sample locations from which to generate simulated LIDAR scans. A map to scan-data transform is performed to generated simulated LIDAR scans 502, 503. The simulated LIDAR scans are used with their associated pose information to train regressor 504. Regressor 504 may then be used to localize in the environment based on a LIDAR scan.

### Localization Based on Orthographic Image

One embodiment relates to more effective methods for image-based localization. A technical challenge with image-based localization is that the camera and perspective used to capture images for mapping may be different than the camera and perspective at runtime, when a UAV is deployed for performing a real service. To address this issue, embodiments herein describe a system and method for stitching map images together into a large orthographic image. An runtime image capture at runtime may be compared to the orthographic image for localization.

In an embodiment, the orthographic image may be created by positioning a plurality of map images based on localization data collected during the mapping process, and the positions may be further refined through local image registrations and geometric optimization. Features may be extracted from the orthographic image and stored in a database. At runtime, a runtime UAV may capture runtime image and extract features. The features of the runtime image may be compared to the features of the orthographic image to localize the runtime UAV.

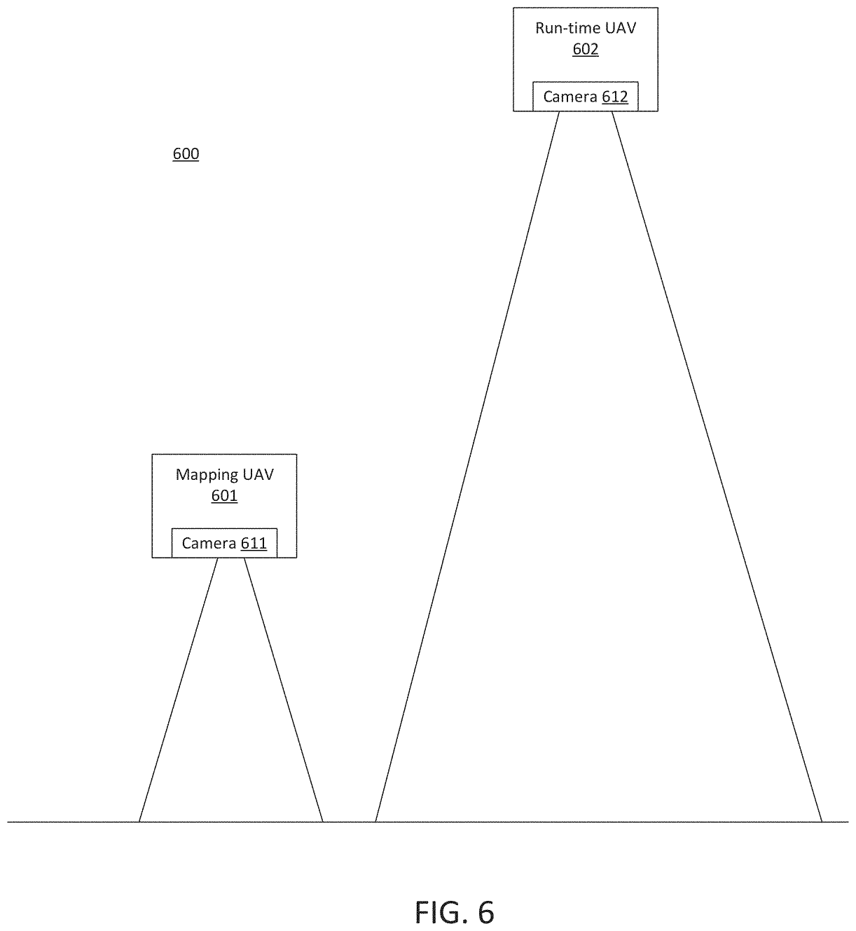

FIG. 6 illustrates an exemplary environment 600 in which some embodiments may operate. Mapping UAV 601 flies in the environment 600 in a systematic manner to map the environment. In particular, UAV 601 comprises camera 611 for capturing images of the environment. Camera 611 may be directed at the ground to capture one or more map images of the ground from the perspective of UAV 601 in order to build a map of the environment 600, which may comprise an orthographic image. After one or more mapping UAVs 601 have collected data from the environment 600 to build the map, a runtime UAV 602 may fly in the environment 600. The runtime UAV 602 performs a task in the environment 600, such as payload delivery, emergency response, traffic monitoring, or other tasks. The runtime UAV 602 may use localization based on the map of the environment created by map images from mapping drone 601. The runtime UAV 602 comprises a camera 612 for capturing images of the ground to perform matching against the map of the environment for localization.

In an embodiment, the images collected by mapping UAV 601 and runtime UAV 602 are different, leading to the technical challenges to be solved herein. In an embodiment, the images collected by mapping UAV 601 have a narrower field of view and have greater detail, while the images collected by runtime UAV 602 have a wider field of view and have less detail. In an embodiment, this difference is due to the mapping UAV 601 flying closer to the ground (at lower altitude) or having a narrower field of view camera 611 than the runtime UAV 602, which may have a wider field of view camera 612. In addition, mapping UAV 601 may include sensors for more precise localization, such as high-quality GPS, IMU, or LIDAR. The precise localization allows map images collected by UAV 601 to be localized precisely to allow building of the environment map, such as the orthographic image. The runtime UAV 602 may lack some or all of these sensors and may rely more heavily on image-based localization from camera 612.

Mapping UAV 601 and runtime UAV 602 may have the same components as UAV 101 and may comprise an IMU 201, imaging system 202, GNSS 203, LIDAR 204, communication system 205, power system 206, processor 207, data storage 208, navigation system 213, and program instructions 212. In an embodiment, the mapping UAV 601 includes an accurate localization system including vision-based, GNSS/GPS, IMU, and structure from motion based sensors and computer systems for localizing the UAV 601 to a high degree of accuracy. One of the trade-offs of the localization system of the mapping UAV 601 is that the sensors and computer systems may be expensive. Runtime UAV 602 may rely on lower-quality GNSS/GPS and may not have a LIDAR 204 in order to reduce component costs. It may rely on lower-quality GNSS/GPS and IMU, combined with image-based localization, described herein, for accurate localization. In some embodiments, the accuracy of localization achieved by the runtime UAV 602 through image-based methods described herein may be the same or may be less than the accuracy of localization achieved by the mapping UAV 601.

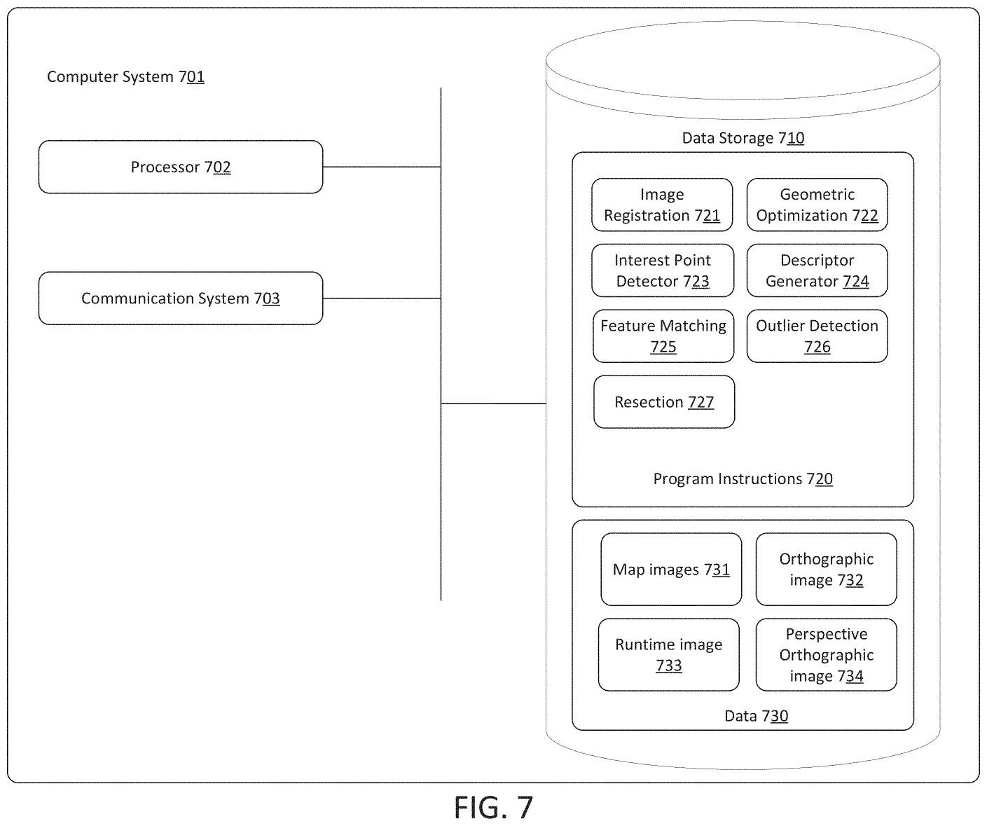

FIG. 7 illustrates an exemplary embodiment of a computer system 701 that may be used in some embodiments to perform functionality described herein. The computer system 701 may generate an orthographic image 732 from map images 731. The computer system 701 may perform localization by comparing runtime image 733 with the orthographic image 732 or perspective orthographic image 734. In some embodiments, a first process of generating the orthographic image 732 from map images 731 is performed on the same computer system as the process of performing localization using the runtime image, and, in other embodiments, the two processes occur on different computer systems.

In some embodiments, the computer system 701 is onboard the mapping UAV 601 or runtime UAV 602. For example, in one embodiment, the processor 702 is the processor 207, the communication system 303 is the communication system 205, and the data storage 310 is the data storage 208.

In other embodiments, the computer system 701 may be offboard the mapping UAV 601 and runtime UAV 602 and may receive the map images 731 and runtime image 733 through communication with the mapping UAV 601 and runtime UAV 602 through communication system 703. After localization, communication system 703 may transmit pose information, comprising a location and orientation, to the mapping UAV 601 or runtime UAV 602.

Processor 702 may include the same features and functionality as processor 302. Communication system 703 may include the same features and functionality as communication system 303. Data storage 710, program instructions 720, and data 730 may include the same features and functionality as data storage 310, program instructions 320, and data 330, respectively.

Image registration module 721 may perform image registrations on one or more images. Image registration may comprise determining an alignment between two different images of the same scene. Image registration may perform the alignment by matching features descriptors or pixels of two or more images. In some embodiments, image registration may be performed on two images taken of an environment at different times and poses to stitch the images into a larger image of the environment.

Geometric optimization module 722 may perform geometric optimization on one or more images depicting a 3D environment from different viewpoints. The 3D environment may comprise a plurality of 3D points and may have been generated previously through image registrations on a plurality of images captured of the environment. The geometric optimization may optimize the 3D environment data and camera pose information to refine the 3D environment and reconstruct it more accurately. In an embodiment, the geometric optimization module 722 simultaneously refines the 3D coordinates describing the scene geometry, parameters of relative motion, and optical characteristics of the camera used to capture the images.

Interest point detector 723 may comprise program instructions for identifying interest points in an image. In an embodiment, interest point detector 723 detects points in an image, where feature descriptors may be generator. In some embodiments, the interest point detector 723 generates interest points that are invariant or partially invariant to changes in perspective or to motion. Characteristics of interest point detector 723 may include scale, rotational, or affine invariance, where the interest points output by interest point detector 723 are invariant or partially invariant to scale, rotation, or affine transforms of the image, respectively. Interest point detector 723 may comprise, for example, Scale-Invariant Feature Transform (SIFT) detector, Harris corner detector, Adaptive Non-maximal Suppression, Shape Adapted, and others.

Descriptor generator 724 may comprise program instructions for generating a feature descriptor at interest points identified by interest point detector 723. Feature descriptors may comprise tensors generated based on application of a function to a local area around one or a small number of pixels in an image and generally characterize a local area of an image. Descriptor generator 724 may comprise, for example, SIFT descriptors, Speeded Up Robust Features (SURF), Gradient Location-Orientation Histogram (GLOH), shape context descriptors, and other descriptors.

Feature matching module 725 may comprise program instructions for identifying a match between one or more feature descriptors. For a query feature descriptor, the feature matching module 725 may search a plurality of stored features descriptors and identify one or more stored feature descriptors that are most similar to the query feature descriptor. Similarity may be measured by a metric specific to the type of feature descriptor but may correspond to the likelihood that the two feature descriptors correspond to the same real-world feature, despite the fact that the feature descriptors may be from different images captured at different times and from a different camera pose.

In an embodiment, feature matching may be performed by storing feature descriptors in a database where they are indexable by an exact match or similarity to the feature descriptor. The database may then be queried by the query descriptor to retrieve one or more matching feature descriptors. In some embodiments, an all-to-all comparison may be performed between a query descriptor and stored feature descriptors to find one or more matching feature descriptors. In other embodiments, the stored feature descriptors may be stored hierarchically so that a hierarchical search may be performed based on the query feature descriptor, where one or more bins at each hierarchical level are selected for expansion based on matching the query feature descriptor and a comparison to individual stored feature descriptors may be performed at the lowest level of the hierarchy.

Outlier detection module 726 may comprise program instructions for identifying outlier matches between feature descriptors in a set of matches. In an embodiment, a plurality of matches between feature descriptors in a query image and a stored image are identified. A statistical model may be generated of a distribution corresponding to the feature descriptor matches. Matches between feature descriptors that do not fit the statistical model may be rejected as outliers. In some embodiments, the outlier detection module 726 may identify a most likely camera pose or geometric transform based on minimizing outliers. In an embodiment, outlier detection module 726 may comprise, for example, Random Sample Consensus (RANSAC).

Resection module 727 may comprise program instructions for inferring a camera pose based on a plurality of images. The images may comprise one or more points with corresponding 3D coordinates to enable the resection. Resection module 727 may comprise, for example, structure from motion, linear n-point camera pose determination, perspective n-point camera pose determination, and other algorithms.

Map images 731 may comprise images captured by mapping UAV 601 and may comprise images collected systematically for building an orthographic image 732, which serves as an environmental map. Map images 731 may include precise localization information collected from mapping UAV 601, where each map image 731 may include a corresponding pose from which the map image 731 was captured. In an embodiment, each pixel of map image 731 includes intensity information, such as an RGB color value, and height information so that the mapping information comprises depth information. Perspective orthographic image 734 may comprise the orthographic image rendered from a specified camera pose. The perspective orthographic image 734 is generated based on the intensity and depth information in the orthographic image 732.

Orthographic image 732 may comprise an image generated by combining a plurality of map images 731 to create a larger image covering a wider view and allowing for more effective comparison to runtime image 733. Like the map images 731, pixels of the orthographic image 732 may comprise both intensity values and depth information. Runtime image 733 may comprise one or more images captured by runtime UAV 602 for localization of the UAV by comparison to the orthographic image 732.

In an embodiment, the individual map images 731 are taken from a lower altitude or at higher resolution so that real-world features comprise a greater number of pixels than in the runtime image 731, which may be taken from a higher altitude or at a lower resolution. Moreover, the runtime image 731 may comprise a wider field of view than the individual map images 731, which may cover a smaller portion of the environment than the larger runtime image 731. Therefore, attempts to localize by directly comparing runtime image 731 to map images may be ineffective. Orthographic image 732 enables the translation of data from a plurality of map images 731 into a format that can be matched with runtime image 733.

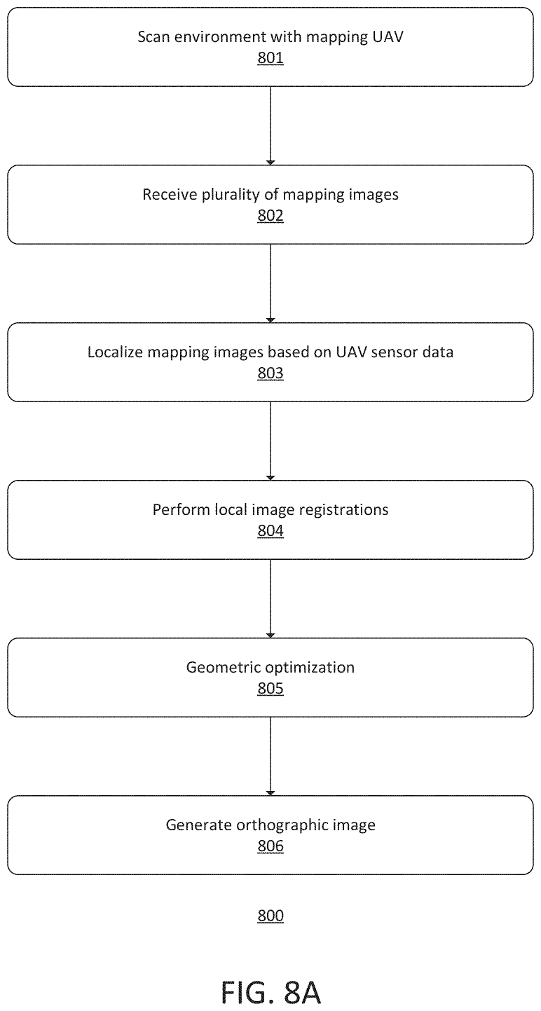

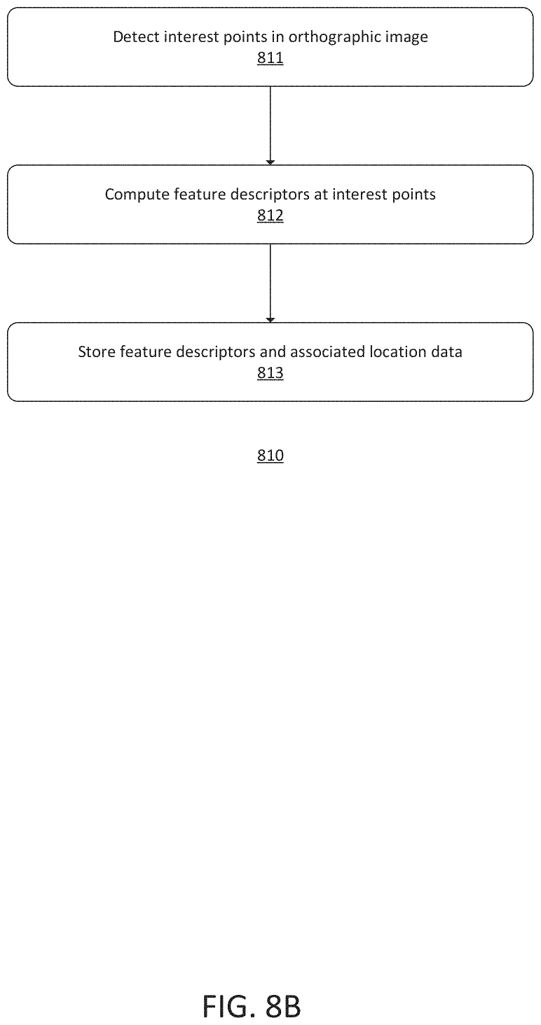

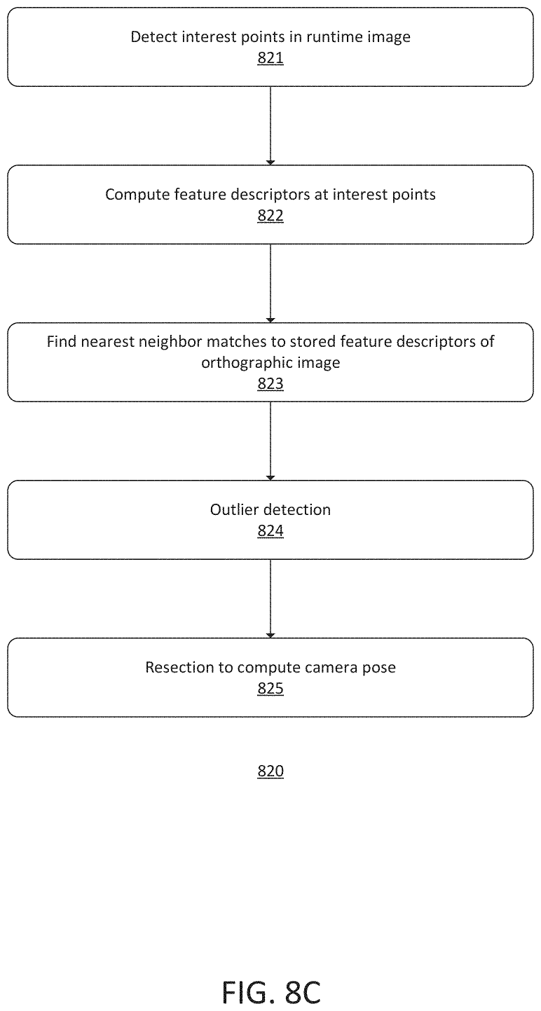

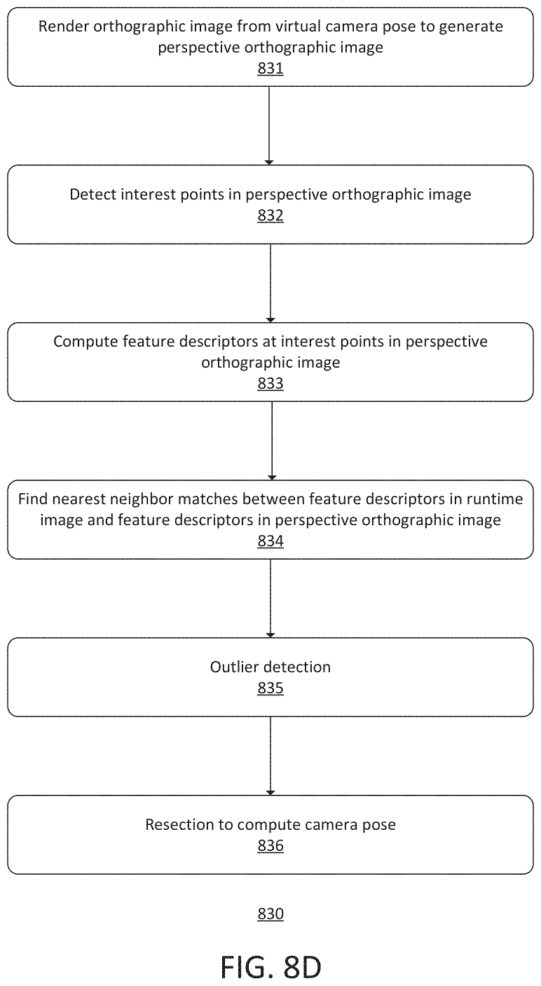

FIG. 8A illustrates an exemplary method 800 for generating orthographic image 732. In step 801, an environment is scanned by a mapping UAV 601 using a camera 611. The mapping UAV 601 may fly systematically in the environment to obtain map images 731 of each portion of the environment. In step 802, a plurality of map images 731 are received. The map images 731 are captured by camera 611 and received at computer 701. Collectively, map images 731 may cover the entire environment, though each individual map image 731 may comprise an image of only a small portion of the environment.

In step 803, the map images may be localized based on sensor data of the mapping UAV 601 to obtain their relative positions. Each map image may include a corresponding camera pose identifying the pose from which the map image was captured. The pose information may be generated by any combination of GNSS/GPS, IMU, LIDAR, image-based localization, and other methods. In some embodiments, sensor fusion may be used to combine localization data from multiple sources. Each of the map images may be placed at a first set of locations based on the associated localization data of the map image.

In step 804, image registration module 721 may perform a series of local image registrations on adjacent or nearby map images 731 to refine their alignment. In an embodiment, the local image registrations may be performed only between map images 731 that are adjacent or nearby and not be performed between map images 731 that are not adjacent or nearby. Image registration may match a plurality of feature descriptors in a first image to a plurality of feature descriptors in a second image to determine a most likely alignment between the two images. After determining the most likely alignment, the new pose information for the map images may be stored.

In step 805, geometric optimization module 722 may perform geometric optimization on the map images 731 to further refine their poses. In step 806, the map images 731 are combined into a single orthographic image by placing each of the map images 731 at the location and orientation as determined in step 805 to stitch the map images 731 together into a single large image.

FIG. 8B illustrates an exemplary method 810 for generating and storing feature descriptors from the orthographic image 732. In step 811, interest point detector 723 detects interest points in the orthographic image. In step 812, descriptor generator 724 computes a feature descriptor at each of the interest points. In step 813, the feature descriptors and associated location data are stored. In an embodiment, the feature descriptors and associated location data are stored in a database that is indexable by the feature descriptor. The feature descriptors and associated location data of the orthographic image 732 are then usable for matching the runtime image 733 to portions of the orthographic image 732.

FIG. 8C illustrates an exemplary method 820 for localizing a runtime UAV 602. In step 821, interest point detector 723 detects interest points in the runtime image 733. In step 822, descriptor generator 724 computes a feature descriptor at each of the interest points. In step 823, feature matching module 725 performs nearest neighbor matching to match each feature descriptor of the runtime image 733 to the stored feature descriptors of the orthographic image 732. As a result of the matching, each feature descriptor of the runtime image 733 is associated with its closest match among the feature descriptors of the orthographic image. Because the orthographic image 732 comprises a plurality of stitched-together map images 731, the feature descriptors of the runtime image 733 may, in effect, be matched against multiple map images 731 at once, and may be matched with feature descriptors from multiple different map images 731. In step 824, outlier detection module 726 may perform outlier detection to identify matching pairs of feature descriptors from the runtime image 733 and orthographic image 732 that are outliers based on building a statistical model of the matches and identifying outliers from the distribution. In one embodiment, RANSAC may be used for outlier detection. In step 825, resection may be performed to compute the camera pose of the runtime UAV 602. Resection may be performed based on the identified correspondences between the feature descriptors of the runtime image 733 and orthographic image 732. By determining the camera pose of the runtime UAV 602 the vehicle is localized.

FIG. 8D illustrates an exemplary method 830 that may optionally be performed in some embodiments to further refine the localization of the runtime UAV 602 after method 820 is performed. At inference time, the perspective of the runtime UAV 602 may be different from the perspective of the orthographic image 732. Localization may optionally be improved in some embodiments by rendering the orthographic image from the camera pose determined by method 820 and performing feature matching and resection again on the rendered orthographic image.

In step 831, orthographic image 732 is rendered by a virtual camera positioned at the camera pose position determined from method 820. The virtual camera is positioned at the camera pose position to replicate the perspective of the runtime UAV 602 in the orthographic image 732. The rendering is performed based on the intensity values and depth values of the pixels in the orthographic image 732. This process generates perspective orthographic image 734, which is a simulated representation of the orthographic image captured from the perspective of the virtual camera.

In step 832, interest point detector 723 detects interest points in the perspective orthographic image 734. In step 833, descriptor generator 724 computes feature descriptors at the interest points in the perspective orthographic image 734. In step 834, feature matching module 725 performs nearest neighbor matching to match each feature descriptor of the runtime image 733 to the feature descriptors of the perspective orthographic image 734. As a result of the matching, each feature descriptor of the runtime image 733 is associated with its closest match among the feature descriptors of the perspective orthographic image 734. Because the perspective orthographic image 734 comprises a plurality of stitched-together map images 731, the feature descriptors of the runtime image 733 may, in effect, be matched against multiple map images 731 at once, and may be matched with feature descriptors from multiple different map images 731. In step 835, outlier detection module 726 may perform outlier detection to identify matching pairs of feature descriptors from the runtime image 733 and perspective orthographic image 734 that are outliers based on building a statistical model of the matches and identifying outliers from the distribution. In one embodiment, RANSAC may be used for outlier detection. In step 836, resection may be performed to compute the camera pose of the runtime UAV 602. Resection may be performed based on the identified correspondences between the feature descriptors of the runtime image 733 and perspective orthographic image 734. By determining the camera pose of the runtime UAV 602 the vehicle is localized. The refined localization of runtime UAV 602 may be more accurate than the initial localization performed by method 820.

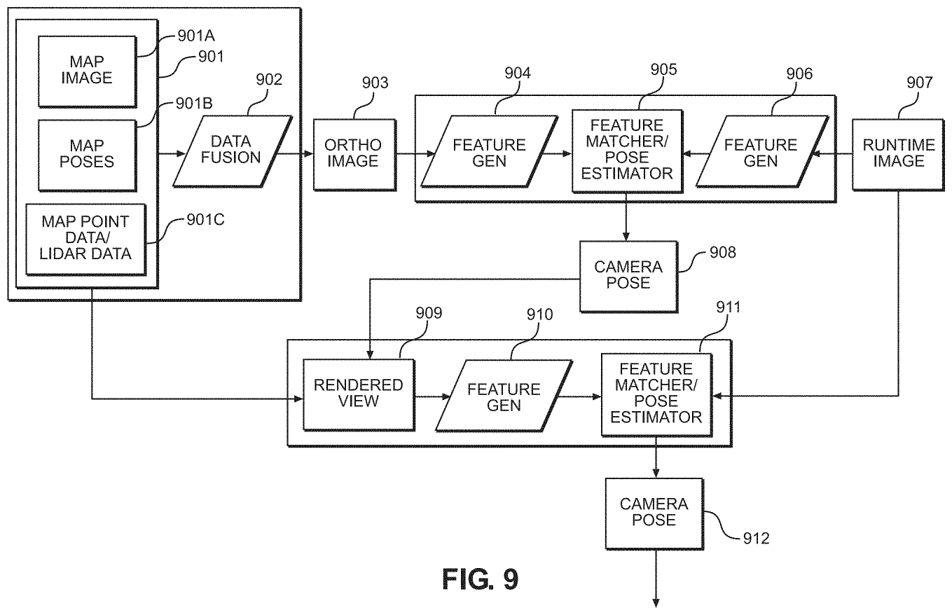

FIG. 9 illustrates an exemplary flow chart of the localization process for runtime UAV 602. In step 901, map images 901a are provided with their map image poses 901b. Map image point data or LIDAR data 901c comprising coordinate or depth data about the map images 901c is provided. In step 902, data fusion is used to generate orthographic image 903. Feature generation 904 is performed to generate feature descriptors on the orthographic image 903. Runtime image 907 is provided and feature generation 906 is performed to generate feature descriptors on the runtime image 907. Feature matcher and pose estimator 905 match features between the orthographic image 903 and runtime image 907 to estimate the camera pose 908 at runtime.

In step 909, a rendered view of the orthographic image 903 is generated based on the mapping data 901 and camera pose 908. Feature generation 910 is performed to generate feature descriptors from the rendered orthographic image. Feature matcher and pose estimator 911 match features between the rendered orthographic image and runtime image 907 to estimate camera pose 912 at runtime.

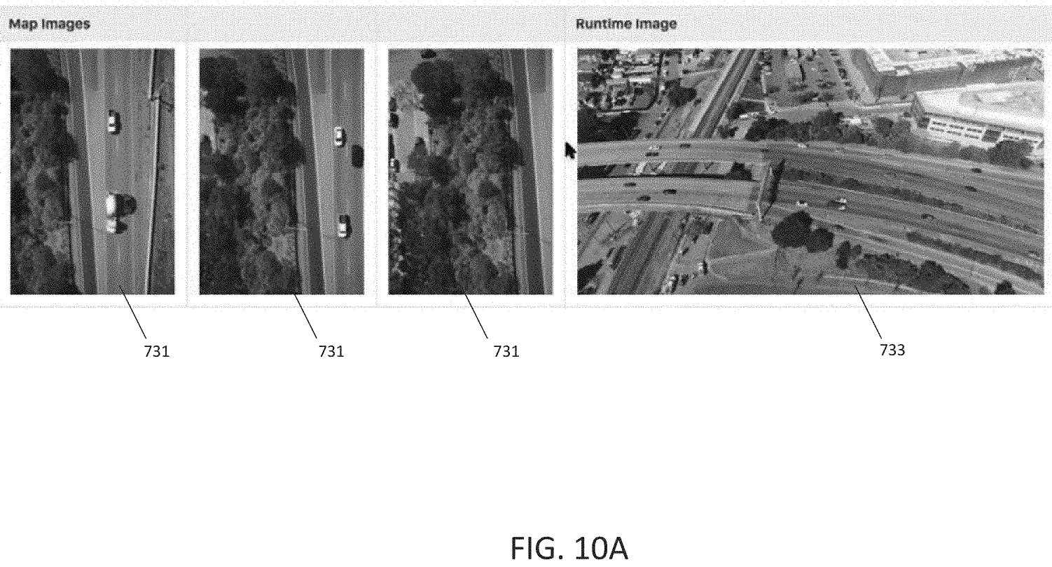

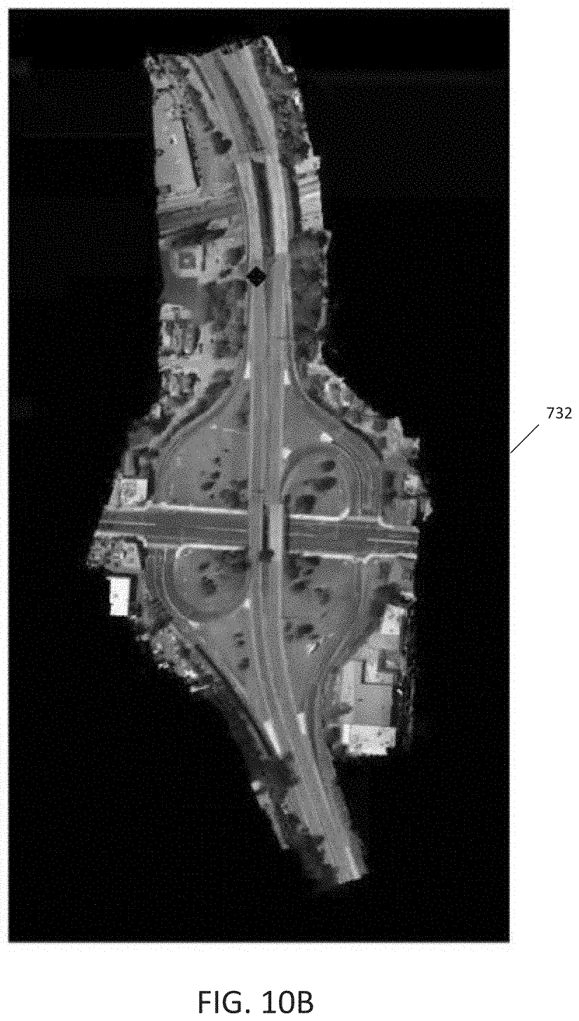

FIG. 10A illustrates exemplary map images 731 and runtime image 733. In an embodiment, map images 731 are captured with a narrow field of view and capture images where real-world features are larger than in runtime image 733. The same real-world feature may comprise many more pixels in map images 731 than in runtime image 733. The runtime image 733 may be captured with a wider field of view than the map images 731.

FIG. 10B illustrates an exemplary orthographic image 732 that may be generated by stitching together multiple map images 731.

Localization Based Off of LIDAR Intensity Point Cloud Map and Single Color Image

One embodiment relates to more efficient methods for image-based localization of a UAV. One advantageous aspect of image-based localization, performed using a camera, as compared with LIDAR is that cameras are less expensive and bulky than LIDAR. Using image-based localization can be more cost-effective and allow UAVs to be smaller than using LIDAR. However, current image-based localization methods have at least two disadvantages. First, they tend to be sensitive to illumination. Changes in illumination may significantly change the pixel values of images. When an image captured at runtime is compared to map images taken at a different time, matches may be missed due to differences in the images that are due to illumination changes. Second, image-based methods require storing large images of the environment, which requires a large memory. By comparison, LIDAR-based localization has lower memory requirements because LIDAR point clouds are sparser. One embodiment, herein combines the advantages of image-based localization with the advantages of LIDAR-based localization and provides a fully or partially illumination-invariant method of image-based localization that has memory requirements similar to those of LIDAR-based methods and only requires a camera at runtime.

In an embodiment, a mapping UAV is used to scan an environment and collect camera images, LIDAR scans, which may comprise 3D point clouds, and pose information. Corresponding camera images and LIDAR images are used to train a first machine learning model to transform camera images into simulated LIDAR images that simulate the LIDAR returns that would be detected by a LIDAR scanner at the location of the camera. In a preferred embodiment, the LIDAR images are LIDAR intensity images that represent the scene as if it was illuminated only by the LIDAR intensity. LIDAR intensity images may be raster images generated from a LIDAR 3D point cloud by interpolation of the intensity information of the points. In another embodiment, the LIDAR images may be LIDAR point clouds.

Corresponding LIDAR images and poses are used to train a second machine learning model to regress from a LIDAR image to a pose. At runtime, a runtime UAV may be equipped with a regular camera for localization. Camera images may be collected and input to the first machine learning model to generate a simulated LIDAR image, and the simulated LIDAR image may be input to the second machine learning model to generate an estimated pose.

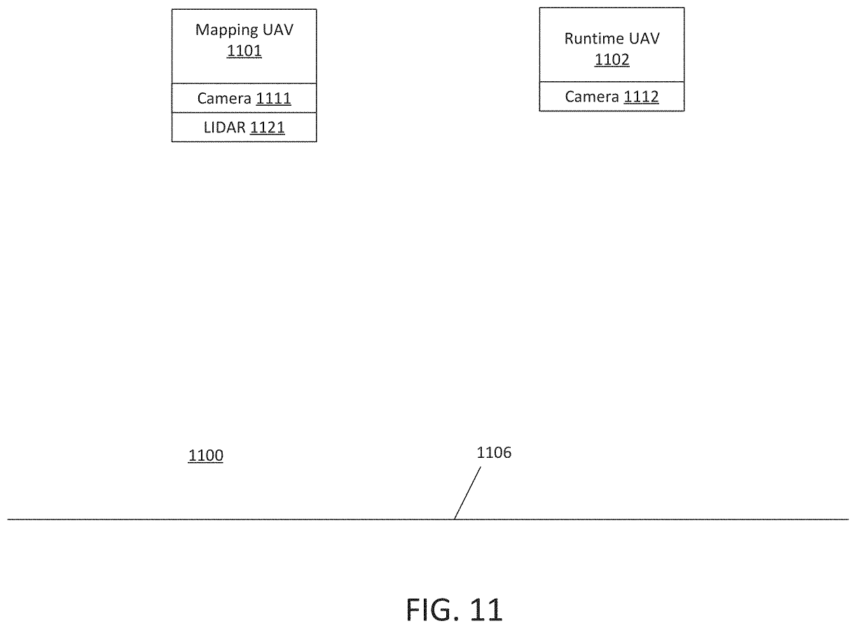

FIG. 11 illustrates an exemplary environment 1100 in which some embodiments may operate. Mapping UAV 1101 flies in an environment 1100 in a systematic manner to map the environment. In particular, mapping UAV 1101 comprises camera 1111 for capturing images of the environment. Camera 1111 may be directed at the ground 1106 to capture one or more images of the ground. In an embodiment, camera 1111 may be a standard RGB camera capturing light at visible wavelengths. In other embodiments, camera 1111 may capture light in non-visible wavelengths. Mapping UAV 1101 further comprises LIDAR 1121 that may be directed at the ground to scan the environment 1100 and generate LIDAR point clouds based on the LIDAR returns. Mapping UAV 1101 may further comprise additional sensors for precise localization of UAV 1101 such as high-quality GPS/GNSS, IMU, LIDAR, and image-based localization systems. Mapping UAV 1101 may perform localization and generate pose information associated with images and LIDAR point clouds. LIDAR intensity images may be generated from the LIDAR point clouds.

After one or more mapping UAVS 1101 have collected data from environment 1100, a runtime UAV 1102 may fly in the environment 1100. The runtime UAV 1102 performs a task in the environment 1100, such as payload delivery, emergency response, traffic monitoring, or other tasks. The runtime UAV 1102 may localize through a two-step process. The runtime UAV 1102 may capture an image with a camera, such as a standard RGB camera, at visible or non-visible wavelengths and process it with a camera image to LIDAR machine learning model to generate a simulated LIDAR image. The runtime UAV 1102 may process the simulated LIDAR image with a LIDAR to pose machine learning model to regress to a pose based on the simulated LIDAR image. The resulting pose may comprise the localization information of the runtime UAV 1102.

Mapping UAV 1101 and runtime UAV 1102 may have the same components as UAV 101 and may comprise an IMU 201, imaging system 202, GNSS 203, LIDAR 204, communication system 205, power system 206, processor 207, data storage 208, navigation system 213, and program instructions 212. In an embodiment, the mapping UAV 1101 includes an accurate localization system including vision-based, GNSS/GPS, IMU, and structure from motion based sensors and computer systems for localizing the UAV 1101 to a high degree of accuracy. One of the trade-offs of the localization system of the mapping UAV 1101 is that the sensors and computer systems may be bulky and expensive. In particular, LIDAR 1121 may be expensive, take up a lot of physical space on mapping UAV 1101, and be heavy. Runtime UAV 1102 may rely on lower-quality GNSS/GPS and may not have a LIDAR 204 in order to reduce component costs, simplify the design, and reduce weight. It may rely on lower-quality GNSS/GPS and IMU, combined with image-based localization, described herein, for accurate localization. In some embodiments, the accuracy of localization achieved by the runtime UAV 1102 through image-based methods described herein may be the same or may be less than the accuracy of localization achieved by the mapping UAV 1101.

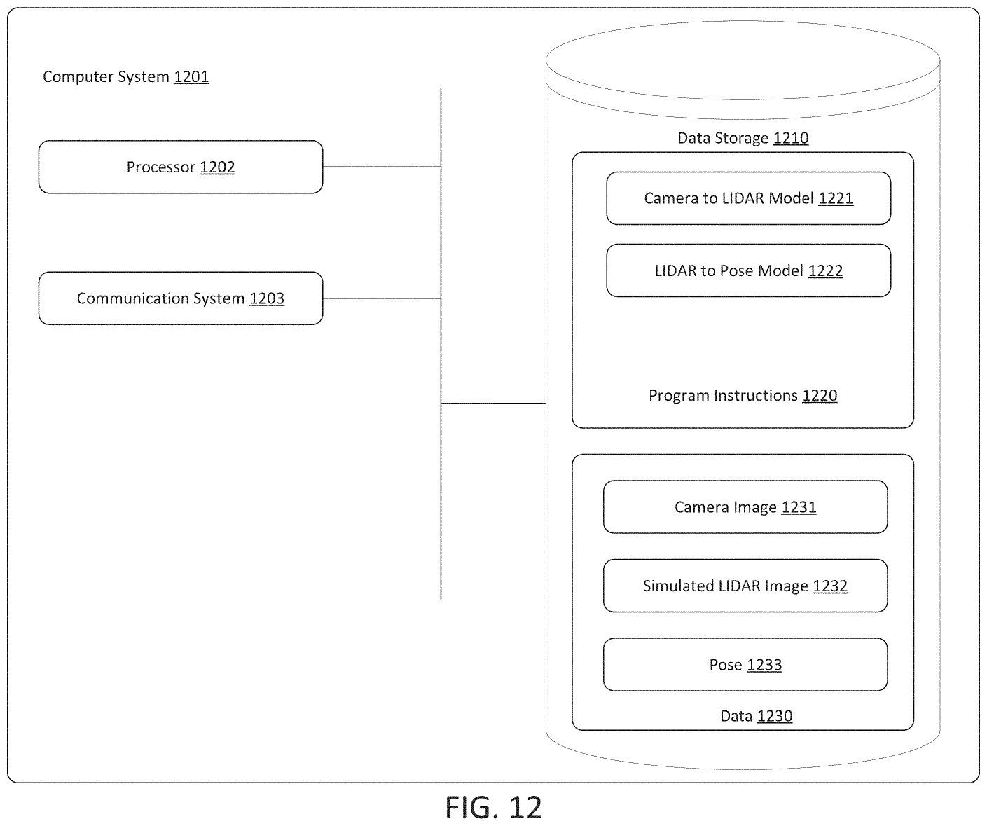

FIG. 12 illustrates an exemplary embodiment of a computer system 1201 that may be used in some embodiments to perform functionality described herein. The computer system 1201 may comprise program instructions for a camera to LIDAR machine learning model 1221 and a LIDAR to pose machine learning model 1222. The computer system 1201 may perform training of the models 1221, 1222 using training examples. The computer system 1201 may use the camera to LIDAR machine learning model 1221 by inputting a camera image 1231 to the model 1221 to generate a simulated LIDAR image 1232. The computer system 1201 may use the LIDAR to pose machine learning model 1222 by inputting a LIDAR image, whether simulated or real, to generate a pose 1233. The pose may comprise the desired localization.

In some embodiments, the computer system 1201 is onboard the mapping UAV 1101 or runtime UAV 1102. For example, in one embodiment, the processor 1202 is the processor 207, the communication system 1203 is the communication system 205, and the data storage 1210 is the data storage 208.

In other embodiments, the computer system 1201 may be offboard the mapping UAV 1101 and runtime UAV 1102 and may receive the camera image 1231 through communication with the mapping UAV 1101 and runtime UAV 1102 through communication system 1203. After localization, communication system 1203 may transmit pose information, comprising a location and orientation, to the mapping UAV 1101 or runtime UAV 1102.

Processor 1202 may include the same features and functionality as processor 302. Communication system 1203 may include the same features and functionality as communication system 303. Data storage 1210, program instructions 1220, and data 1230 may include the same features and functionality as data storage 310, program instructions 320, and data 330, respectively.

Camera to LIDAR model 1221 may comprise a machine learning model for translation between a camera image 1231, such as a color RGB image, to a LIDAR image 1232. The camera to LIDAR model 1221 may accept as input the camera image 1231 and transform it to generate LIDAR image 1232. The camera to LIDAR model 1221 may include model parameters that affect the output of the model and that are adjusted through training. The camera to LIDAR model 1221 may comprise any machine learning model such as a neural network, deep neural network, convolutional neural network, recurrent neural network, attention-based neural network, random forest, generative adversarial network (GAN), support vector machine (SVM), regressor, and other machine learning models.

LIDAR to pose model 1222 may comprise a machine learning model for translation between a LIDAR image 1232 to a pose, which may comprise location coordinates and an orientation. The LIDAR to pose model 1222 may accept as input a LIDAR image, whether a real LIDAR image generated from a real LIDAR scanner or a simulated LIDAR image 1232 generated using a machine learning model, and generate an estimated camera pose 1233. The camera pose may locate the camera position and orientation in environment 1100. The LIDAR to pose model 1222 may include model parameters that affect the output of the model and that are adjusted through training. The LIDAR to pose model 1222 may comprise any machine learning model such as a neural network, deep neural network, convolutional neural network, recurrent neural network, attention-based neural network, random forest, generative adversarial network (GAN), support vector machine (SVM), regressor, and other machine learning models.

Camera image 1231 may comprise an image captured from camera 1111 or 1112. In an embodiment, the camera image 1231 is a color image captured in the visible wave lengths by a standard color camera. The pixel data of camera image 1231 may encoded, for example, as RGB, CMYK, or other values.

Simulated LIDAR image 1232 may comprise a LIDAR intensity image or LIDAR point cloud. The simulated LIDAR image 1232 may simulate a LIDAR image generated by a LIDAR scanner, but in fact may be generated by the machine learning model 1221 based on camera image 1231. In some embodiments, the simulated LIDAR image 1232 is indistinguishable from a true LIDAR image generated from a real LIDAR scanner. In other embodiments, the simulated LIDAR image 1232 may differ from a true LIDAR image but is sufficiently similar to be used for pose estimation.

Pose 1233 may comprise an estimated pose generated by the LIDAR to pose machine learning model 1222.

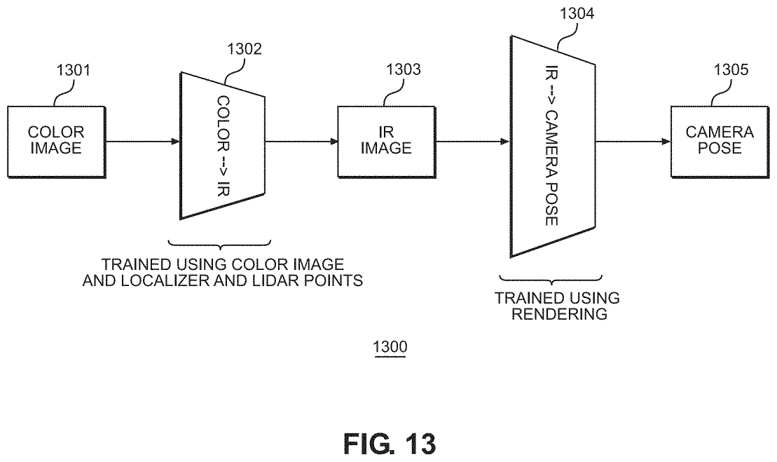

FIG. 13 illustrates an exemplary flow chart of a localization process 1300 for runtime UAV 1102. In an embodiment, color image 1301 is captured by camera 1112 and provided to localization process 1300. In step 1302, color image 1301 is transformed into a LIDAR image 1303 by the camera to LIDAR model 1221. The camera to LIDAR model 1221 may be trained using color images, localization information, and corresponding LIDAR images. In step 1304, the LIDAR image 1303 is used to predict the camera pose 1305 by using the LIDAR to pose model 1222. The LIDAR to pose model 1222 may be trained using simulated or real LIDAR images and their corresponding poses.

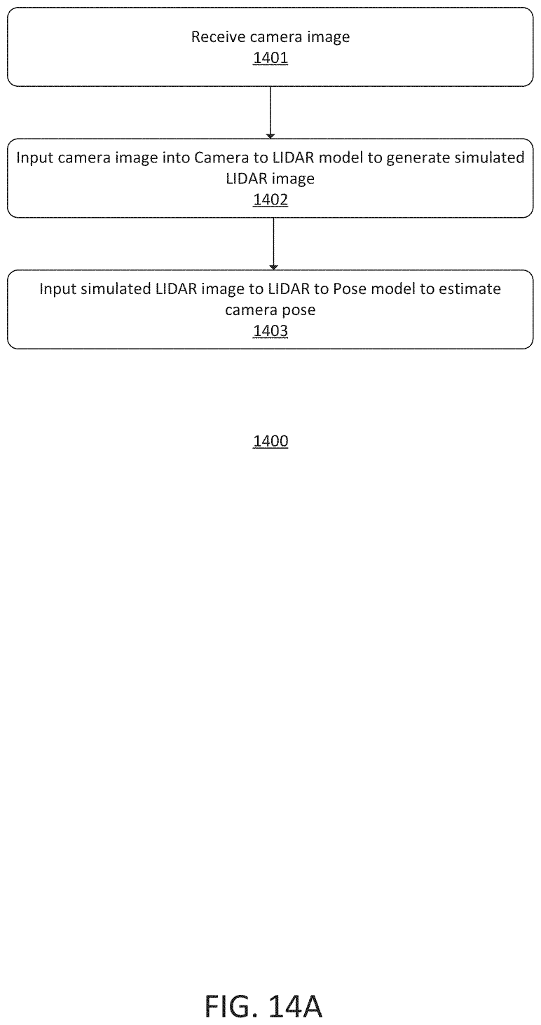

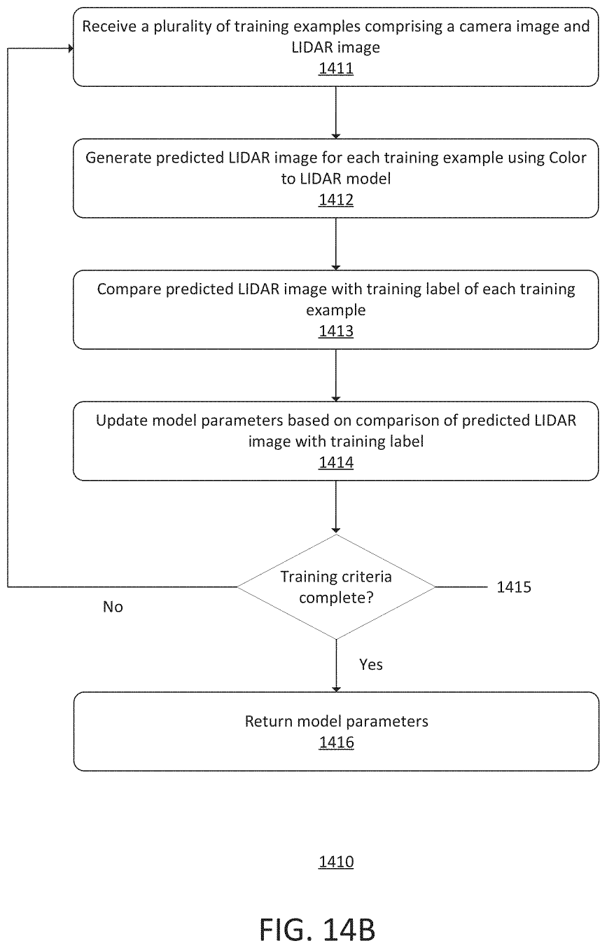

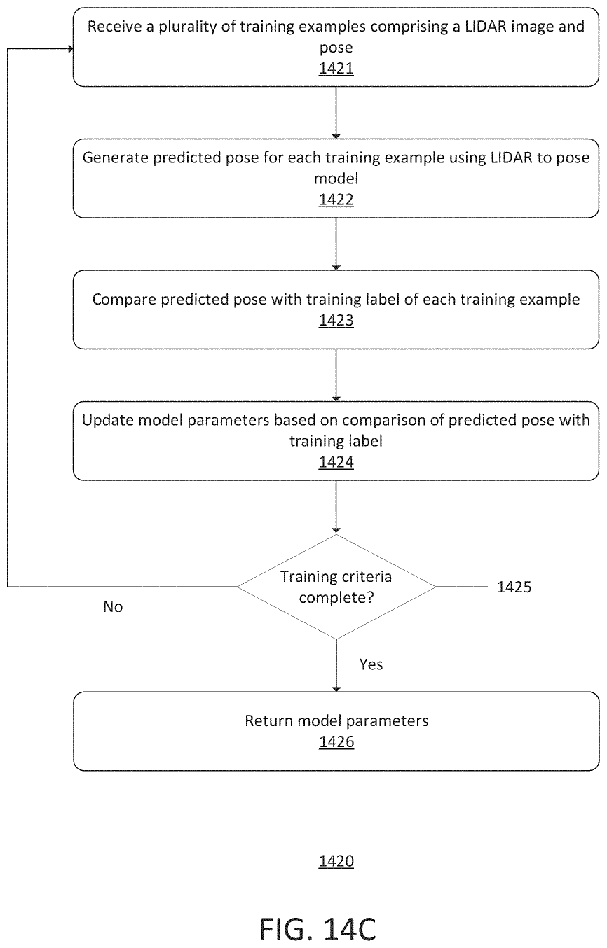

FIG. 14A illustrates an exemplary method 1400 for localizing runtime UAV 1102. In step 1401, a camera image 1231 is received. The camera image 1231 comprises an image captured by camera 1112 of runtime UAV 1102. In some embodiments, a plurality of camera images 1231 may be collected and used. In step 1402, the camera image 1231 is input to the camera to LIDAR model 1221 to generate a simulated LIDAR image 1232. In step 1403, the simulated LIDAR image 1232 is input to the LIDAR to pose model 1222 to estimate the camera pose of the runtime UAV 1102.

FIG. 14B illustrates an exemplary method 1410 for training the camera to LIDAR model 1221. In step 1411, a plurality of training examples are received, each training example comprising a camera image as training input and a LIDAR image as training label. The training examples may be collected from camera images and corresponding LIDAR image scanned from the same pose by mapping UAV 1101. In step 1412, the camera to LIDAR model 1221 may be used to generate a predicted LIDAR image for each training input. In step 1413, the predicted LIDAR image may be compared with the training label for each training example. In step 1414, model parameters of the camera to LIDAR model 1221 may be updated based on the comparison of the predicted LIDAR image and the training label. In step 1415, it is determined whether training criteria have been completed. If so, then the process may end and, in step 1416, the updated model parameters for camera to LIDAR model 1221 may be returned 1416. If not, then the process may repeat at step 1411.

FIG. 14C illustrates an exemplary method 1420 for training the LIDAR to pose model 1222. In step 1421, a plurality of training examples are received, each training example comprising a LIDAR image as training input and a pose as training label. In an embodiment, the training examples may be collected from the LIDAR point clouds or intensity images scanned by mapping UAV 1101 and the corresponding poses. In an embodiment, some or all of the training examples may be generated synthetically from camera images. For example, camera images may be captured by mapping UAV 1101 and may be input to camera to LIDAR model 1221 to generate simulated LIDAR images. The simulated LIDAR images may be used as training inputs with their corresponding poses from which the camera images were captured as training labels.

In step 1422, the LIDAR to pose model 1222 may be used to generate an estimated posed for each training input. In step 1423, the predicted pose may be compared with the training label for each training example. In step 1424, model parameters of the LIDAR to pose model 1222 may be updated based on the comparison of the predicted pose and the training label. In step 1425, it is determined whether training criteria have been completed. If so, then the process may end and, in step 1426, the updated model parameters for LIDAR to pose model 1222 may be returned 1426. If not, then the process may repeat at step 1421.

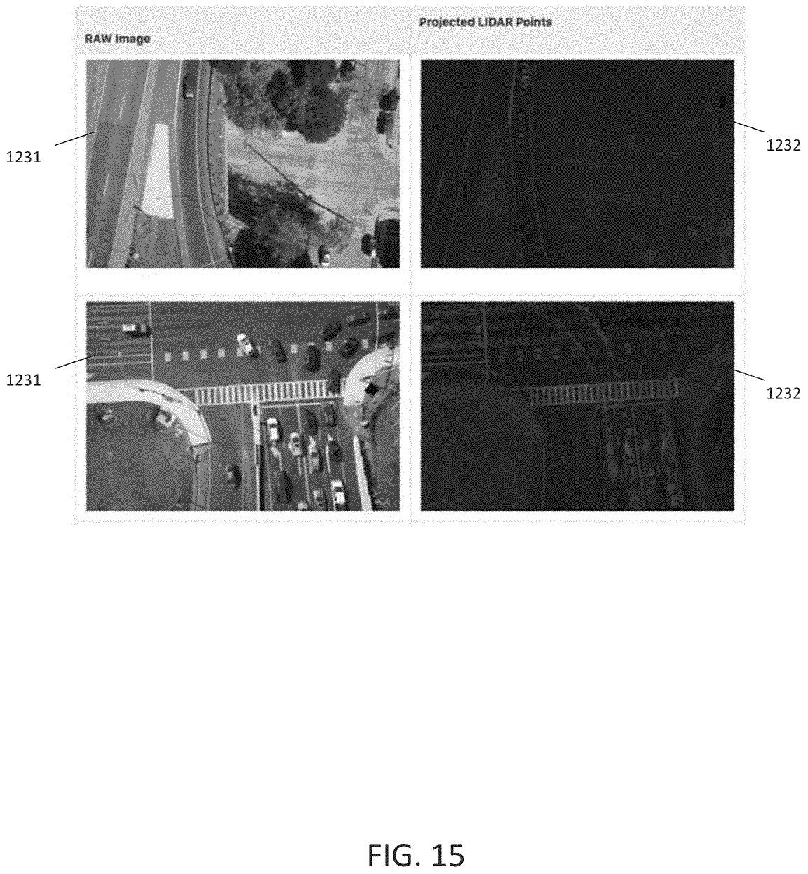

FIG. 15 illustrates exemplary camera images 1231 and corresponding simulated LIDAR images generated by camera to LIDAR model 1221.

A number of implementations have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps may be eliminated, from the described flows, and other components can be added to, or removed from, the described systems. Accordingly, other implementations are within the scope of the following claims.

What is claimed is:

1. A computer-implemented method for localization comprising:
receiving an aerial LIDAR scan at a scan position, wherein the scan position is aerial, and generating a LIDAR point cloud from the aerial LIDAR scan;
sampling one or more locations inside the LIDAR point cloud, each of the sampled locations being a ground position different from the scan position;
simulating the LIDAR returns from the one or more sampled locations based on the LIDAR point cloud to generate one or more simulated LIDAR scans, each of the simulated LIDAR scans having a different perspective than the aerial LIDAR scan;
generating a training set of training examples, each training example comprising a training input including one of the simulated LIDAR scans and a training label including the corresponding sampled location;
training, using the training set, a regressor to generate an estimated pose based on an input inference-time LIDAR scan.

2. The computer-implemented method of claim 1, wherein the LIDAR point cloud is generated without using any ground-based LIDAR scans.

3. The computer-implemented method of claim 1, further comprising:
receiving a ground-based LIDAR scan from a ground vehicle at an inference-time scan position and generating the input inference-time LIDAR scan from the ground-based LIDAR scan;
inputting the input inference-time LIDAR scan into the regressor to generate the estimated pose.

4. The computer-implemented method of claim 1, further comprising:
mapping the estimated pose to world coordinates using georeference data.

5. The computer-implemented method of claim 1, wherein the regressor comprises a random forest.

6. The computer-implemented method of claim 1, wherein the regressor comprises a deep neural network.

7. A computer-implemented method for localization comprising:
receiving a plurality of map images and corresponding pose data;
performing a first localization of the map images using the pose data to generate a first set of coordinates and orientation for each of the map images;
performing a second localization of the map images by performing local image registrations between map images to generate a second set of coordinates and orientation for each of the map images;
performing geometric optimization to refine the second set of coordinates and orientation of the map images;
combining the map images into an orthographic image based on the refined second set of coordinates and orientation of the map images;
receiving a runtime image;
performing feature matching between the runtime image and orthographic image to generate an estimated pose of the runtime image.

8. The computer-implemented method of claim 7, further comprising:
detecting a first plurality of interest points in the orthographic image;
computing a first plurality of feature descriptors at the first plurality of interest points;
storing the first plurality of feature descriptors for comparison to the runtime image.

9. The computer-implemented method of claim 8, further comprising:
detecting a second plurality of interest points in the runtime image;
computing a second plurality of feature descriptors at the second plurality of interest points;
performing feature matching between the second plurality of feature descriptors and first plurality of feature descriptors to generate a plurality of feature matches.

10. The computer-implemented method of claim 9, further comprising performing nearest neighbor feature matching between the second plurality of feature descriptors and first plurality of feature descriptors to generate the plurality of feature matches.

11. The computer-implemented method of claim 10, further comprising performing outlier detection to detect and discard one or more outlier feature matches.

12. The computer-implemented method of claim 11, further comprising performing resection to generate the estimated pose of the runtime image.

13. The computer-implemented method of claim 12, further comprising:
rendering the orthographic image from the estimated pose of the runtime image to generate a perspective orthographic image;
detecting a third plurality of interest points in the perspective orthographic image;
computing a third plurality of feature descriptors at the third plurality of interest points;
performing feature matching between the third plurality of feature descriptors and second plurality of feature descriptors to generate a second plurality of feature matches.

14. The computer-implemented method of claim 13, further comprising performing outlier detection to detect and discard one or more outliers from the second plurality feature matches.

15. The computer-implemented method of claim 14, further comprising performing resection to generate a refined estimated pose of the runtime image.

16. A computer-implemented method for localization comprising:
receiving a color image comprising a plurality of RGB pixel values;
inputting the color image to a trained camera to LIDAR machine learning model to generate a simulated LIDAR intensity image;
inputting the simulated LIDAR intensity image to a trained LIDAR to pose machine learning model to generate an estimated pose corresponding to the color image.

17. The computer-implemented method of claim 16 further comprising:
creating the trained camera to LIDAR machine learning model by training with a plurality of training examples, each training example comprising a training input including a training set color image and a training label including a corresponding LIDAR intensity image.

18. The computer-implemented method of claim 16 further comprising:
creating the trained LIDAR to pose machine learning model by training with a second plurality of training examples, each of the second plurality of training examples comprising a training input including a training set LIDAR intensity image and a training label including a corresponding pose.

19. The computer-implemented method of claim 18, wherein each of the training set LIDAR intensity images are synthetically generated by the camera to LIDAR machine learning model.

20. The computer-implemented method of claim 16, wherein the camera to LIDAR machine learning model comprises a GAN.
